(19) United States
(12) Patent Application Publication
(10) Pub. No.: US 2015/0047202 A1
(43) Pub. Date: Feb. 19, 2015

(54) RAZOR BLADE ASSEMBLY AND SHAVING DEVICE USING SAME

(71) Applicants: Yossef Rosemberg, Raanana (IL); Mark Funt, Kfar Saba (IL)

(72) Inventors: Yossef Rosemberg, Raanana (IL); Mark Funt, Kfar Saba (IL)

(21) Appl. No.: 14/460,208

(22) Filed: Aug. 14, 2014

Related U.S. Application Data
(60) Provisional application No. 61/865,677, filed on Aug. 14, 2013.

(51) Int. Cl. B26B 21/40; B26B 21/58; B26B 21/60

(52) U.S. Cl. CPC B26B 21/405; B26B 21/4081; B26B 21/60; B26B 21/58
USPC 30/34.05; 30/346.5; 30/346.53; 132/200

(57) ABSTRACT

A blade assembly and razor utilizing same are provided. The blade assembly includes at least one blade and an electrode element being electrically insulated from the blade and from a skin surface contactable by the blade. The blade in combination with the electrode form hydroxyl ions near the blade edge during shaving.

### CROSS-REFERENCE TO RELATED APPLICATION

The application claims the benefit of the earlier filing date of co-pending U.S. Provisional Patent Application No. 61/865,677, filed Aug. 14, 2013 and incorporated herein by reference.

### FIELD AND BACKGROUND OF THE INVENTION

The present invention relates to a razor blade assembly and a shaving device using same and specifically, to a blade assembly capable of electrolytically producing hydroxyl ions at the shaving front to thereby retard regrowth of shaved hair.

The skin is the second largest organ in the body after the skeleton and is integral to the survival of mammalian life. Significant to the many properties of skin is the hair follicle.

The total number of hair follicles for an adult human is estimated at 5 million with 1 million on the head of which 100,000 alone cover the scalp. In humans, the only external regions of skin devoid of hair follicles are the palms of the hands and soles of the feet. The hair follicle is a separate structure within the skin; its formation and maintenance is due to an interaction between dermal and epidermal components. Each hair follicle includes a dermal papilla (DP) which includes epidermal cells that actively proliferate, differentiate and become keratinized to form the hair cortex (Co) and surrounding hair cuticle (Hc) of the hair shaft at the center of which is situated the medulla (M). Cells around the hair shaft comprise the inner root sheath (IRS) which can be divided into three layers: the cuticle (Cu), Huxley layer (Hu) and Henle layer (He). The inner root sheath breaks down at the level of the sebaceous gland to leave only the hair cortex and surrounding cuticle to protrude above the epidermis.

Although hair provides a vital function to humans as well as animals, it is often regarded as cosmetically unappealing and as such, numerous approaches for hair removal have been devised.

Hair removal is a time-consuming daily routine for many people. While traditional methods such as shaving waxing, tweezing, and trimming are effective for removing unwanted hair, they do not provide long-term solutions for hair removal.

Devices effective in long term hair removal are known in the art and include, for example, lasers and electrolysis needles. Such devices require a clinical setting and a skilled technician and as such are not typically suitable for home use. In addition, treatment via these devices can be painful as well as time consuming and expensive to the treated individual.

Typically, hair removal can be effected using one of two general approaches. Depilation affects the part of the hair above the surface of the skin. The most common form of depilation is shaving. Another popular option is the use of chemical depilatories, which work by breaking the disulfide bonds that link the protein chains that give hair its strength, making the hair disintegrate. Epilation is removal of the entire hair, including the part below the skin, and is therefore longer-lasting. Methods include waxing, sugaring, mechanical epilation devices, lasers, threading, intense pulsed light or electrology.

Although presently used approaches for hair removal are somewhat effective, use thereof requires long treatment sessions as well as, in some cases, expensive devices which require operation by a skilled technician in a clinical setting.

Attempts to overcome these limitations has led to the development of hand held devices which utilize an electric current to drive substances into the skin and hair root for the purpose of destroying the dermal papilla.

Such devices are described in, for example, U.S. Pat Nos. 6,206,869, 7,996,994 and 8,343,147.

While such devices can theoretically traverse the limitations of presently used hair removal devices, there remains a need for an easy to use and highly effective hair removal and regrowth retardation device.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates the blade assembly of the present invention.

FIG. 2 illustrates a shaving device utilizing the blade assembly of FIG. 1.

FIG. 3 schematically illustrates the electrical effect of the blade assembly of the present invention showing electrolytic generation of hydroxyl ions at the blade cutting edge.

FIGS. 4a-d illustrate migration into the hair shaft of hydroxyl ions formed by the present blade assembly.

FIGS. 5a-b illustrate regrowth of hair shaved with a standard razor (FIG. 5a) and with the present razor assembly (FIG. 5b).

### DETAILED DESCRIPTION

The present invention is of a device that can be used for removing unwanted hair and retarding its regrowth. The embodiments of the present invention successfully address the shortcomings of the presently known configurations by providing a simple, easy to use hair shaving device which generates growth-suppressing hydroxyl ions at the vicinity of the shaved hair strand without running a current through the tissue and causing discomfort to the user.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

The principles and operation of embodiments of the present invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

Thus, according in one embodiment a shaving blade assembly which can shave a hair shaft while concomitantly generating hydroxyl ions at the shaving front (blade cutting edge) is provided. This effectively removes hair and retards regrowth. As used herein, the phrase “hair removal and regrowth retardation” refers to complete or partial (thinning) removal of hair and/or retardation of hair growth or re-growth. Any hair covering any portion of a subject's body can be treated with the present composition. Examples include appendage hair (arms, legs), facial hair (beard, mustache, eyebrows), scalp hair, torso hair (back, chest), pubic hair and the like.

The subject can be any subject requiring or desiring such treatment, including human males or females as well as other mammals.

The blade assembly of embodiments of the present invention includes at least one blade and an electrode element that is electrically insulated from the blade(s) and from a skin surface contactable by the blade(s).

The blade assembly also includes a housing for carrying the blade(s). As is further described hereinbelow, the electrode element can be attached to the blade or to the housing.

The blade is electrically connectable to a negative terminal of a power source while the electrode element is electrically connectable to a positive terminal of the power source.

When the blade assembly is connected to the power source and the cutting edge of the blade contacts a skin surface in the presence of a conductive medium that includes water molecules (e.g., sweat, water, shaving cream), a current is generated between the cutting edge of the blade (that acts as a negative electrode) and the electrode element (positive electrode). This current between the electrodes produces the following reactions and products:

(i) Negative electrode (blade) −2H₂O electrolyzes to 2OH⁻ +H₂ gas.

(ii) Positive electrode (electrode element) −2H₂O electrolyzes to 4H⁺ +O₂

Since the hydroxyl ions are generated by the moving blade as it shaves off protruding hair shafts, a relatively high concentration of hydroxyl ions are formed at the base of the shaved shaft which then acts as a conduit for transport of hydroxyl ions into the hair root. Without being bound to a theory, the present inventors propose that the hydroxyl ion gradient results in transport of the hydroxyl ions into the hair shaft.

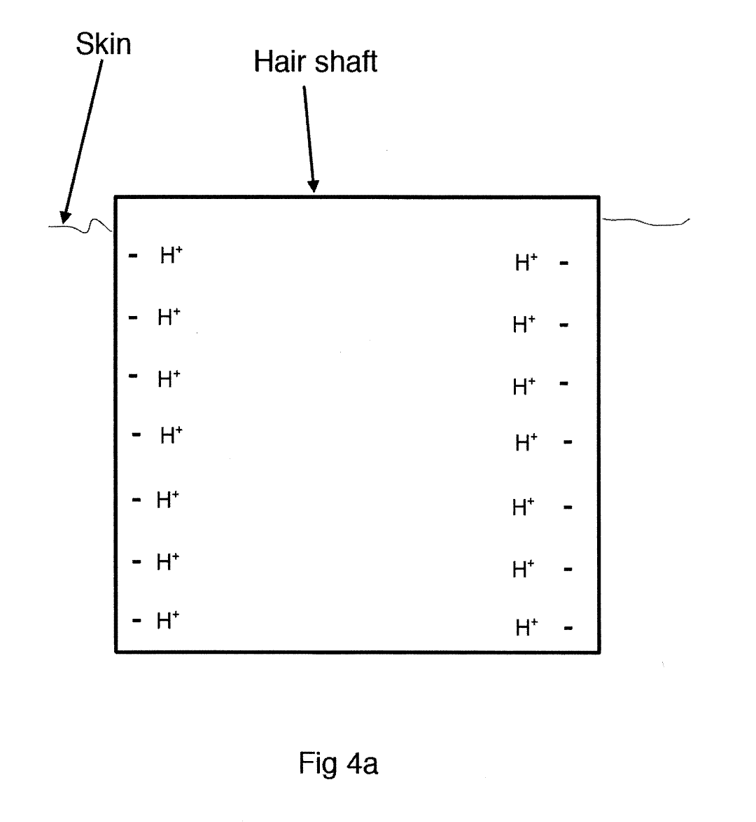

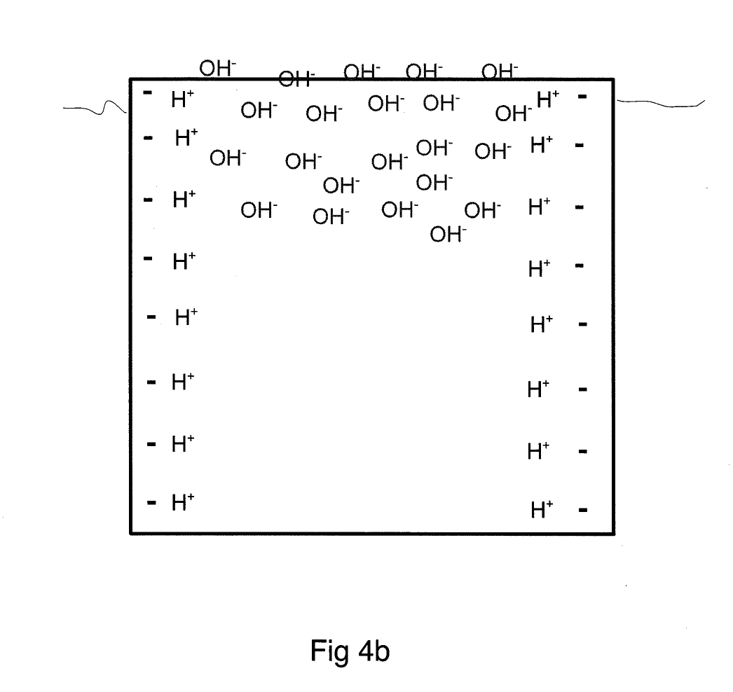

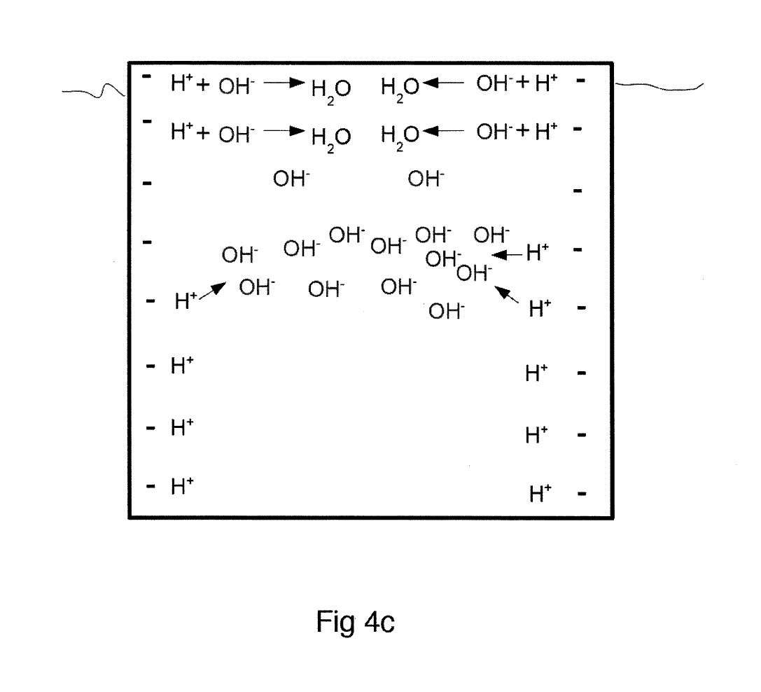

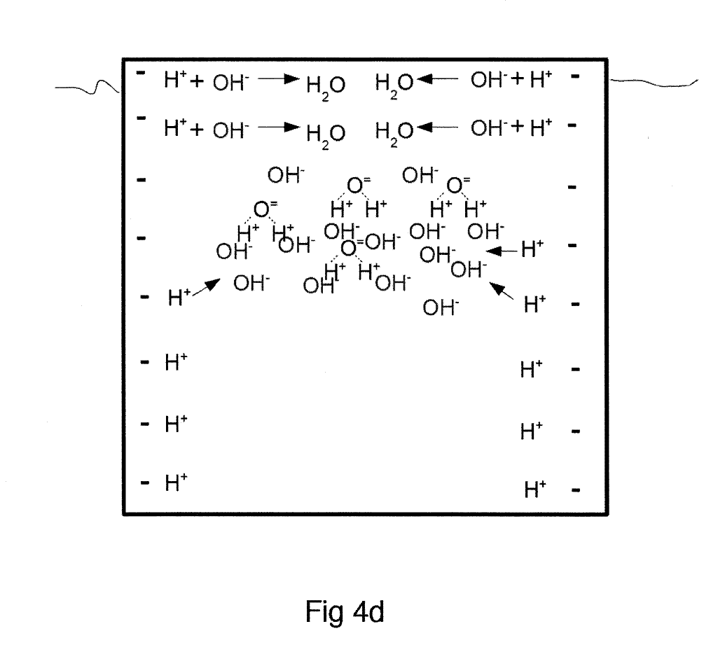

The proposed transport mechanism driving the electrolytically-formed hydroxyl ions into an exposed hair shaft (shaved by blade assembly 10) is shown in FIGS. 4a-d.

The cuticle and cortex of a hair shaft are highly negatively charged and as such attract protons (FIG. 4a). The high concentration of protons in the hair shaft attracts the hydroxyl ions formed via electrolysis of water by blade assembly 10 (FIG. 4b). The hydroxyl ions penetrate the hair shaft and react with the protons down the hair shaft to form water via a highly exothermic reaction. The hydroxyl ions in the solution absorb more water from the surroundings, thereby increasing the volume of the hydroxyl solution and further pushing the hydroxyl ions down the hair shaft towards the root.

These transport mechanisms result in efficient migration of the hydroxyl into the shaved hair shaft and root. The basic environment formed by the hydroxyl solution permeating the root destroys cells participating in hair growth (e.g., papillary cells).

The blade assembly of the present invention can be used in any shaving device including razors (safety razors, disposable razors, straight edge razors, etc.), electric shavers, and the like.

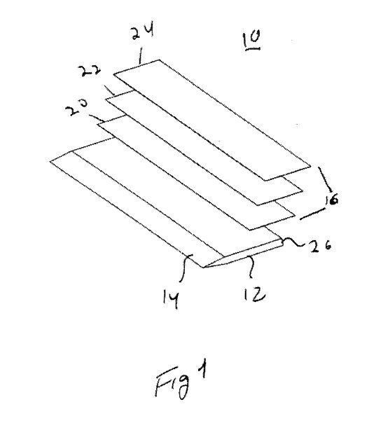

FIG. 1 illustrates one embodiment of the blade assembly of the present invention, which is referred to herein as assembly 10. This Figure shows the separate layers of the electrode element and the blade from the skin-facing side of the blade.

Assembly 10 includes a blade 12 having a beveled cutting edge 14. Blade 12 can be fabricated from cold rolled precision steel strips using processes well known in the art such as blanking, degreasing, hardening and tempering, grinding and sputtering/PFTE coating and the like. One preferred material for blade 12 is stainless steel having for example 13% Chromium, 0.4% Silicon, 0.015% Sulfur, 0.25% Phosphorous, 0.05% Manganese, 0.067% Carbon and the rest Iron.

Blade 12 is substantially rectangular in shape with a length of 20-40 mm, a width of 2-22 mm and a thickness of 50-200 microns (100 microns preferred).

Blade 12 can be coated with any coating known in the art including, for example, Teflon (PTFE) and the like. Such coating protects the blade and increases its service life. Blade 12 preferably includes a hydrophilic coating for increasing the wettability of blade 12. Such a coating can include, for example, a surfactant such as sodium dodecyl sulfate or Ammonium lauryl sulfate (ALS), Sodium myreth sulfate, Dioctyl sodium sulfosuccinate (DSS), Perfluorooctanesulfonic acid or perfluorooctane sulfonate (PFOS), Sodium lauroyl sarcosinate. The coating also preferably covers the electrode element, attached to, or printed on the lower blade surface as is further described hereinbelow.

Assembly 10 further includes an electrode element 16 positioned on a skin-facing surface 18 of blade 12. Electrode element 16 is positioned such that when blade 12 (cutting edge 14) contacts a skin surface, electrode element 16 is displaced away from the skin and does not directly contact it. This ensures that an electric current between electrode element 16 (acting as a positive electrode) and blade 12 (acting as a negative electrode) can only be established through a current carrying liquid medium (e.g., sweat, water, shaving cream) which is in contact with both electrodes.

Electrode element 16 includes three layers (shown separately in FIG. 1), layer 20 (closest to blade surface) includes an insulator, while layers 22 includes conductive material. Layer 24 can also include a conductive material as well as being inert and biologically compatible. Table 1 below lists several material options for construction of electrode element 16.

TABLE 1
electrode element material

| Electrode | | | | |
|---|---|---|---|---|
| Element | Layer 20 | Layer 22 | Layer 24 | Comments |
| Option 1 | Polymer | Silver | Graphite | Separately printed and |
| | | | | bonded to a blade |
| Option 2 | Lacquer | Gold | Graphite | Printed on a blade |
| Option 3 | Ceramic | Copper | Graphite | Sputtered on a blade |

Layers 20, 22 and 24 can be printed on, or bonded to surface 18 of blade 12 (or fabricated using a combination of printing and bonding). In order to ensure that electrode element 16 does not directly contact the skin when blade assembly 10 is in use, electrode element is bonded or printed on a portion of surface 18 nearest back end 26 (opposite cutting edge 14) of blade 12 at a distance of 300-2000 microns from blade edge 14. The area of electrode element 16 can be anywhere from 20-600 mm².

Electrode element 16 can be printed on surface 18 via screen or inkjet printing or any other known printing/coating approach. Layers 20, 22 and 24 are printed sequentially using an insulative ink in layer 20 and conductive inks in layers 22 and 24. Layer 20 can be printed from polymer or lacquer, while layer 22 can be printed from a silver-based ink or a gold-based ink. Layer 24 can be printed from graphite. An additional insulative layer can be printed over layer 24 to ensure no electrical contact between electrode element 16 and skin.

Printing electrode element 16 ensures minimal thickness and provides a relatively easy and inexpensive way to fabricate electrode element 16 directly on blade 12. The thickness of a printed electrode element 16 can be anywhere from 9-90 microns with each layer (20, 22 or 24) being 3-30 microns in thickness.

Electrode element 16 can also be bonded on blade 12. In such an embodiment, electrode element 16 can be fabricated by bonding a thin film insulator, e.g., polyester or polycarbonate (layer 20) to a thin film layer of a conductive material, e.g. silver or gold (layer 22) and an additional thin film layer including graphite (layer 24). In such an embodiment, the thin film insulator (layer 20) is typically in the range of 30-100 mm.

The fabricated multilayer electrode element 16 can then be bonded to surface 18 of blade 12.

As is mentioned above, electrode element 16 can also be fabricated using a combination of bonding and printing. For example, a thin film layer 20 can be printed with layers 22 and 24 and then bonded to surface 18 of blade 12.

Regardless of the fabrication approach, bladed assembly can be coated with a hydrophilic material such as sodium dodecyl sulfate (SDS) or any of the abovementioned surfactants to increase wettability. Such a coating can be applied via dipping or spraying approaches.

As is mentioned hereinabove, blade assembly 10 can be incorporated into or attached to any device suitable for shaving.

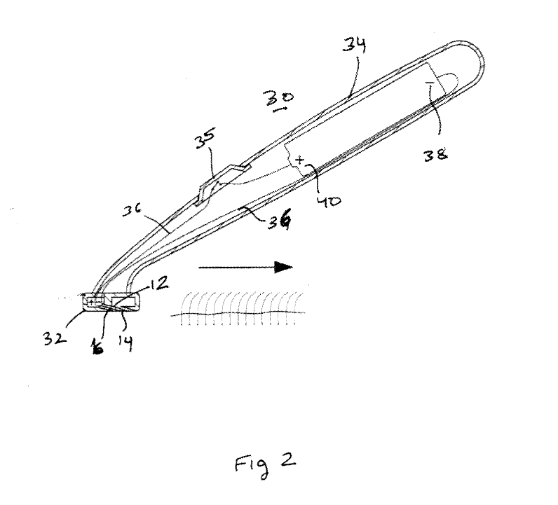

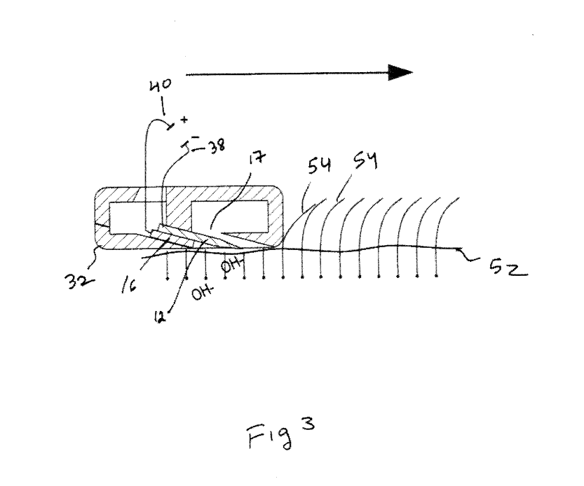

FIG. 2 illustrates a manual razor 30 utilizing blade assembly 10 in a razor cartridge 32. Cartridge 32 includes a housing for carrying razor assembly 10 and any number of additional shaving blades (e.g., 1-5 more blades). Additional blades can be mounted above blade 12 in space 17 shown in FIG. 3. Housing of cartridge 32 can include a lubricating strip, channels for guiding and aligning hair shafts and any other features incorporable into razor cartridges. Housing of cartridge 32 can be fabricated from a polymer using well known fabrication approaches.

Blade assembly 10 can be mounted within housing at an angle suitable for shaving (e.g., 10-23 degrees). In such a configuration, an additional insulative outer layer (facing skin) is not needed since housing of cartridge 32 encompasses electrode element 16 and prevents it from contacting the skin.

Cartridge 32 can further include a handle connector (not shown) for removably connecting housing of cartridge 32 to handle 34 (e.g., tongue-in-groove clip). Handle 34 can be fabricated from a polymer using well known approaches. Handle 34 is configured as a standard razor handle to be operated via a hand of a user.

Blade assembly 10 further includes electrical connections 36 for connecting blade 12 and electrode element 16 to negative 38 and positive 40 terminals (respectively) of a power source (e.g., battery). Handle 34 can include a switch 35 for turning on power supply to electrode element 16 and blade 12.

The power source can be a 4-10 Volt battery producing a current of 70-150 mA between the electrodes. While such a current is effective in producing hydroxyl capable of migrating to the hair root and suppressing hair regrowth, it does not cause any discomfort to the user.

Electrical paths can be printed on blade assembly to connect blade 12 and electrode element 16 to electrical contacts at the handle connector of cartridge 32. For example, an electrical path can be printed on the top side (side facing away from skin and electrode element) over an insulative layer to connect blade 12 to a negative electrical contact at the handle connector of cartridge 32 and a separate path can be printed on the side facing skin to connect electrode element 16 to a positive electrical contact at the handle connector of cartridge 30. Once cartridge 32 is connected to handle 34, the contacts at the handle connector engage similar contacts at the handle to establish electrical connectivity between blade 12 and negative terminal 38 and electrode assembly 16 and positive terminal 40 through electrical connections 36.

Once connected to the power source, blade 12 (specifically cutting edge 14) and electrode element 16 can establish an electrical current through a current-carrying medium (e.g., water, sweat, shaving cream/foam) disposed on the skin. As such, when handle 34 is used to position cartridge 32 with cutting edge 14 against a skin surface an electrochemical reaction takes place in the current carrying medium, electrolyzing water molecules and forming hydroxyl ions at cutting edge 14 (and H₂ gas) and forming H⁺ and O₂ at electrode element 16 (which is displaced from the skin and in contact with the current-carrying medium).

FIG. 3 illustrates the electrochemical reaction and formation of hydroxyl ions at cutting edge 14. As blade 12 is moved along a surface of skin 52, cutting edge 14 shaves off protruding hair shafts 54. A current running between cutting edge 14 (negative electrode) which contacts the skin and surrounding current-carrying medium (not shown) and electrode element 16 (positive electrode) which only contacts the current-carrying medium electrolyzes water molecules (in the current-carrying medium) at cutting edge 14 thereby forming hydroxyl ions at or near the shaved hair shafts. The hydroxyl ions (OH⁻) migrate through the shaved hair shaft under the electrochemical gradient formed by electrolysis and penetrate the shaft and root as is described hereinabove with reference to FIGS. 4a-d. Thus, shaving using the present blade assembly can result in suppression of hair regrowth and a marked reduction in a need for shaving.

The electrolytic reaction generated by blade assembly 10 involves a series of steps. At first, electron transfer occurs at a tunneling distance (typical less than 2 nm) between the reactant (water), and the negative electrode (blade 12, specifically cutting edge 14), the products of this electron transfer (OH⁻ and H₂,) than migrate away from the negative electrode.

The amount of OH− produced is a direct function of the electrical current that flows through blade assembly 10.

The basic reactions of Electrolysis are as follows:

Cathode : 2 H₂O(l)+2e− →H₂(g)+2 OH⁻ (aq)

Anode: 2 H₂O(l)→O₂(g)+4 H⁺ (aq)+4e−

Two electrons are needed to produce 1 molecule of H₂(g) and 2 molecules of OH⁻ (aq) at the cathode. The charge of an electron is: 1.60217657×10⁻¹⁹ Coulombs; 1 ampere=1 Coulomb/sec, so the number of electrons that flow through blade assembly 10 for a current of 1 ampere equals:

1/1.60217657×10⁻=6.2415×10¹⁸ electrons

which will produce 62415×10¹⁸ molecules of OH⁻(aq).

The number of molecules present in a mole is defined by Avogadro's number −6.022×10²³. As such, the number of moles that will be produced by blade assembly 10 is 6.2415×10¹⁸/6.022×10²³=1.04×10⁻⁵ moles per amp.

A blade assembly 10 which includes a positive electrode having an area of ˜600 mm² connected to a 4-10 Volt power source capable of producing a current of 70-150 mA will produce about 1-2.6 nmol of OH⁻ for every mm² of blade edge 14 (negative electrode) every second.

Thus, the present invention provides a blade assembly and razor using same which can be used for facial, as well as body (e.g., legs, abdomen, back) hair removal and hair growth suppression.

As used herein the term “about” refers to ±10%.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following example, which together with the above descriptions, illustrate the invention in a non limiting fashion.

### Example 1

### Shaving with the Present Blade Assembly

A blade assembly was constructed by bonding a positive electrode to a disposable stainless steel blade. The positive electrode included a silver layer (conductive layer) and two graphite layers (conductive biocompatible layer) printed on 0.1 mm polyester film (insulator).

The blade assembly was immersed in 15% SDS and dried at room temperature (hydrophilic treatment).

The hands of an adult male subject were shaved five times (1 shave/week) using the blade assembly (left hand) and a standard razor (right hand) and hair regrowth was monitored in both hands over the course of 5 weeks.

The blade assembly was connected to a standard AC to DC adapter (SKL SAKAL Electronics, input: AC 220 50 Hz 20.5 VA Output: DC 3-12 Volt 800 mA) and the output was set to 12 volt. The blade assembly was immersed in 3% surfactant prior and during shaving to maintain the current at between 70-150 mA. The standard razor was used along with SDS and water.

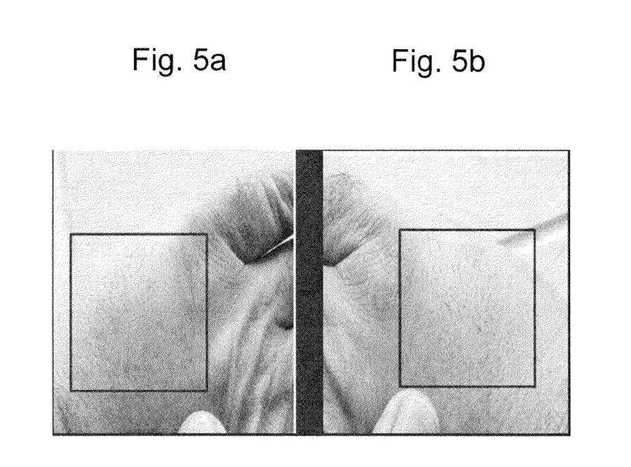

No skin damage or irritation of the treated areas was observed during, after or between treatments. Following 5 weeks of treatment, clear hair regrowth suppression was observed with the present blade assembly (FIG. 5b) as compared to the standard blade (FIG. 5a). The area treated by the present blade assembly was characterized by fewer and smaller hairs when compared to the area treated by the standard razor. This clearly indicates that hair-producing cells were damaged/suppressed by treatment with the present invention.

Although the invention has been described in conjunction with specific embodiments thereof, it is evident that many alternatives, modifications and variations will be apparent to those skilled in the art. Moreover, embodiments of the invention are described by way of example and not by way of limitation. It should be noted that different references to “an” or “one” embodiment in this disclosure are not necessarily to the same embodiment, and such references mean at least one. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A blade assembly suitable for shaving comprising:
at least one blade and an electrode element carried by the blade and being electrically insulated from said at least one blade and from a skin surface contactable by said at least one blade wherein a current flows between the blade and electrode when connected to a power supply in the presence of a conductive fluid.

2. The blade assembly of claim 1, wherein said electrode element is bonded or printed on a surface of said at least one blade.

3. The blade assembly of claim 2, wherein said electrode element includes at least one conductive layer displaced from said surface of said at least one blade via an insulating layer.

4. The blade assembly of claim 3, wherein said electrode element is printed on said surface of said blade and further wherein said insulating layer is 3-30 microns thick.

5. The blade assembly of claim 3, wherein said electrode element is bonded onto said surface of said blade and further wherein said insulating layer is 30-100 microns thick.

6. The blade assembly of claim 3, wherein said at least one conductive layer includes silver and graphite and said insulating layer includes a polymer.

7. The blade assembly of claim 3, wherein said at least one conductive layer is biocompatible.

8. The blade assembly of claim 1, wherein said at least one blade is electrically connectable to a negative terminal of a power source and said electrode element is electrically connectable to a positive terminal of a power source.

8. The blade assembly of claim 1, wherein a distance between a cutting edge of said at least one blade and said electrode element is 300-2000 micron.

10. The blade assembly of claim 1, further comprising a housing for carrying said at least one blade.

11. The blade assembly of claim 10, wherein said electrode element is mounted in or on said housing.

12. The blade assembly of claim 1, wherein said at least one blade is coated with a hydrophilic material.

13. The device of claim 1, wherein said at least one blade is fabricated from a steel or chromium alloy.

14. The blade assembly of claim 12, wherein said electrode is coated with said hydrophilic material.

15. The device of claim 12, wherein said hydrophilic material is a surfactant.

16. The device of claim 2, wherein said surface is a skin-contacting surface of said blade further comprising:
a skin-facing electrical insulating shield covering the electrode.

17. The device of claim 10, wherein said housing is configured for attachment to a user-operated handle.

18. The device of claim 2 further comprising:
a power source; and
a printed conductive path from a negative terminal of the power source to the blade.

19. A device for removing hair comprising:
(a) a handle operable by a user;
(b) a device head attachable to said handle and including a blade assembly having at least one blade having a cutting edge and an electrode element being electrically insulated from said at least one blade and from a skin surface contactable by said at least one blade;
said at least one blade in conjunction with the electrode element electrolyzing water molecules to form hydroxyl ions at the cutting edge thereof when said electrode element is connected to a positive terminal of a power supply and said at least one blade is connected to a negative terminal of a power supply and positioned against said skin surface.

20. The device of claim 19, wherein said electrode element is bonded to or printed on a surface of said at least one blade.

21. The device of claim 19, wherein both said at least one blade and said electrode element are coated with a hydrophilic material.

22. The device of claim 19, wherein said device head includes a housing for carrying said at least one blade.

23. The device of claim 22, wherein said electrode element is mounted in or on said housing.

24. The device of claim 19, wherein said handle includes said power supply.

25. A method of shaving comprising:
(a) providing a blade assembly having at least one blade connected to a negative terminal of a power source and an electrode element connected to a positive terminal of said power source, said electrode element being electrically insulated from said at least one blade and from a skin surface contactable by said at least one blade; and
(b) moving said blade assembly along said skin surface to thereby shave off hair and electrolyze water molecules at a cutting edge of said at least one blade to form hydroxyl ions.
